(19) United States
(12) Patent Application Publication
(10) Pub. No.: US 2006/0156633 A1
(43) Pub. Date: Jul. 20, 2006

(54) Injection molded sash and method

(75) Inventors: James C. Guhl, Hudson, WI (US); David J. Weiss, Stillwater, MN (US); Frank Campbell, Lake Elmo, MN (US); Kathleen Barton, Birchwood, MN (US); Craig Michael Johnson, St. Paul, MN (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Andersen Corporation, Bayport, MN (US)

(21) Appl. No.: 11/027,681

(22) Filed: Jan. 3, 2005

(51) Int. Cl. E06B 1/04

(52) U.S. Cl. 49/504

(57) ABSTRACT

A window sash is formed from a pair of one-piece injection molded sash body members having substantially the same mechanical configuration. Each sash body member has an inner, facing surface and a non-facing surface. The facing surface of each sash body member is provided with a plurality of locators of two different types, arranged about axis of anti-symmetry. The two different types of locators are complementary to one another, and so are configured to engage each other. This allows a window sash to be formed of substantially identical components that are mated together. Each sash member may be provided, on its facing surface, with a weld wall that is set back from the outer sash member edges. The window sash may be assembled after heating the weld walls and joining the two substantially identical sash members.

### BACKGROUND

The present invention is directed to sashes formed from injection molded parts, and windows and doors comprising such sashes.

The advantages of polymeric materials for the manufacture of window sashes have long been appreciated. Polymers such as polyvinyl chloride (PVC) have advantages over wood and metal in that they are resistant to rotting and corrosion, while also having relatively good thermal insulating properties and weatherability. Insulating properties of window sashes made of polymeric materials can be further enhanced by incorporating one or more internal air spaces.

A traditional method for manufacturing products from polymeric materials is injection molding, wherein a fluid material is injected into a mold to form the shape of the desired product. The injected material can be a molten thermoplastic that solidifies upon cooling, or a reactive fluid material that solidifies upon undergoing a chemical reaction. While injection molding has the potential advantage of being able to produce parts of high complexity, high dimensional consistency, and low cost, these advantages accrue primarily when large volumes of the same part are produced. This is due in no small part to the cost of producing each mold, particularly molds for large complex parts.

Because the fenestration industry requires the production of a large variety of sizes and styles of window sashes, and because window sashes tend to be large and complex in their configuration, injection molding of sashes requires a large capital investment in molds. This method of production has therefore been less advantageous for this industry than certain other methods. Nevertheless, as exemplified U.S. Pat. Nos. 6,749,797 and 5,189,841, whose contents are incorporated by reference, there have been efforts made in the past to form a window sash and/or a window frame by injection molding.

### SUMMARY OF THE INVENTION

In one aspect, the present invention is directed to a window sash. The window sash includes first and second sash body members having substantially the same mechanical configuration and engaged to another, with a glazing unit held between the sash body member. Each of the first and second sash body members is a one-piece, injection molded component.

Preferably, each of the first and second sash body members has a inner, facing surface provided with a plurality of locators, the locators on the first sash body member are engaged to the locators on the second sash body member.

In one embodiment, each sash body member is provided with locators of a first type and locators of a second type, the locators of the first and second types being different from one another and complementary to each other. The locators of the first type may each comprise a slot and locators of the second type each comprise a blade. On each sash body, the locators of the first and second types are arranged anti-symmetrically about an axis. The locators of both first and second types may be provided on each of four sides of a four-sided sash body member.

In another embodiment, the locators are all identical. In such case, the locators may comprise holes formed in the facing surface of each sash body member, a plurality of first holes in the first sash body member opposing second holes formed in the second sash body member. A pin may received in each of said opposing first and second holes to help locate one sash body member relative to the other.

In another embodiment, the locators serve the dual function of locating the two sash bodies relative to one another while also linking them to one another. In this embodiment, one locator is a small diameter projection, while the other locator is a larger diameter aperture. A toothed ring, or washer, is provided, wherein the inner and outer peripheries of the washer have projections for engaging the locators. The ring is placed over a smaller, projecting, locator of one of the sash body members, so that the inner peripheral teeth engage the projection, and an aperture locator of the other sash body member is placed over the washer so that the outer peripheral teeth engage the inner surface of the aperture. The engagement of the peripheral teeth with the locators thereby serves to link the two sash body members while also locating them relative to one another.

While locators incorporated internally into the sash body members are useful, sash body members which do not have locators incorporated therein are also contemplated. In the absence of internally incorporated locators, external fixtures can be used to provide suitable location of the two sash body members relative to one another during assembly.

Each of the sash body members may comprise a weldable mating surface. In one embodiment, the weldable mating surfaces comprise a substantially continuous rib.

The assembled window sash may include additional features, such as recesses configured to receive a balancer or a check rail component.

Each sash body member may have a different color, such that one side of the window sash has a different color than the other side of the window sash.

In another aspect, the present invention is directed to a window having one or more such window sashes in a frame. The window may be a single-hung window, or a double-hung window.

In yet another aspect, the present invention is directed to a window sash having first and second sash body members with a glazing unit sandwiched between them. Each of the sash body members has substantially the same mechanical configuration, being originally formed from identical injection molds and then subsequently joined to one another.

In still another aspect, the present invention is directed to a one-piece injection molded window sash body member. The sash body member comprises a inner, facing surface, and a non-facing surface. A first plurality of locators of a first type and a second plurality of locators of a second type are provided on the facing surface, the locators of the first and second types being different from one another, complementary to each other, and arranged anti-symmetrically about an axis of the facing surface. The sash body member is four-sided, with locators of both first and second types provided on each of four sides.

Such sash body members, when joined to form a window sash, are adapted to receive a variety of accessory parts chosen to provide a desired window configuration. Thus, a line of window products using injection molded sash body members may thus be formed. Such a line of window products would then require a reduced number of molds while providing a range of window sash configurations.

Assembly of the sash is performed by placing a sash body member on each side of a glazing unit of suitable size, in mating fashion, with suitable sealants, and attaching the two members together by, for example, hot plate welding, adhesives, mechanical fasteners, or other suitable attachment means. It is preferred that the interface between the two sash body members also be sealed against moisture penetration, although weep holes or other drainage or venting features may be provided. The sealing sash body members can either be performed by the welding process or the adhesive materials, or additional sealing material can be provided.

Constructing the claimed window panels using the system of one-piece sash bodies and optionally selectable accessory parts claimed herein reduces the number of different injection molded sash body members needed for a full line of window panels, while at the same time preserving many of the advantages of injection molding, at a cost less than that normally associated with injection molding of a wide range of different parts.

Hot plate welding can be performed by providing a series of heated bars positioned over the surfaces of the sash members to be welded, heating the surfaces by means of the bars, removing the bars, and pressing the sash members together. The heated bars can have adjustable positioners to accommodate a range of sash member sizes and configurations.

### BRIEF DESCRIPTION OF THE DRAWINGS

The invention is now described with reference to the attached drawings in which:

FIG. 1 shows a window assembly including a lower window sash in accordance with the present invention;

FIG. 1A shows a window assembly including an upper window sash in accordance with the present invention;

FIG. 2 shows an exploded view of the window sash in the window unit of FIG. 1;

FIG. 2A shows a cross sectional view of a sash body member in accordance with the present invention;

FIG. 3 shows the inner, facing surface of a sash body member, with locators symbolically represented in accordance with one aspect of the present invention;

FIG. 4 shows the inner, facing surface of an injection molded one-piece window sash body member in accordance with the present invention;

FIG. 5 shows a detailed view of one embodiment of a pair of complementary locating members;

FIG. 5A shows an alternative locator and fastening configuration in accordance with one aspect of the present invention;

FIG. 5B shows an asymmetric arrangement for the locator and fastening configuration shown in FIG. 5A;

FIG. 6 shows a tool used to heat the facing surface of a one-piece window sash body member;

FIGS. 6A-6H show a hot plate welding apparatus and steps for performing a welding operation in accordance with one aspect of the present invention;

FIG. 7 shows a cross-sectional view of a pair of joined, complementary locking members, taken along line 7-7 of FIG. 1;

FIG. 7A shows a cross-sectional view of a pair of joined, complementary locking members, taken along line 7-7 of FIG. 1, with a check rail cover attached;

FIG. 8 shows a detailed view of a second embodiment of a pair of complementary locating and fastening members;

FIG. 9 shows a double hung window incorporating a pair of assembled window sashes in accordance with the present invention.

### DETAILED DESCRIPTION

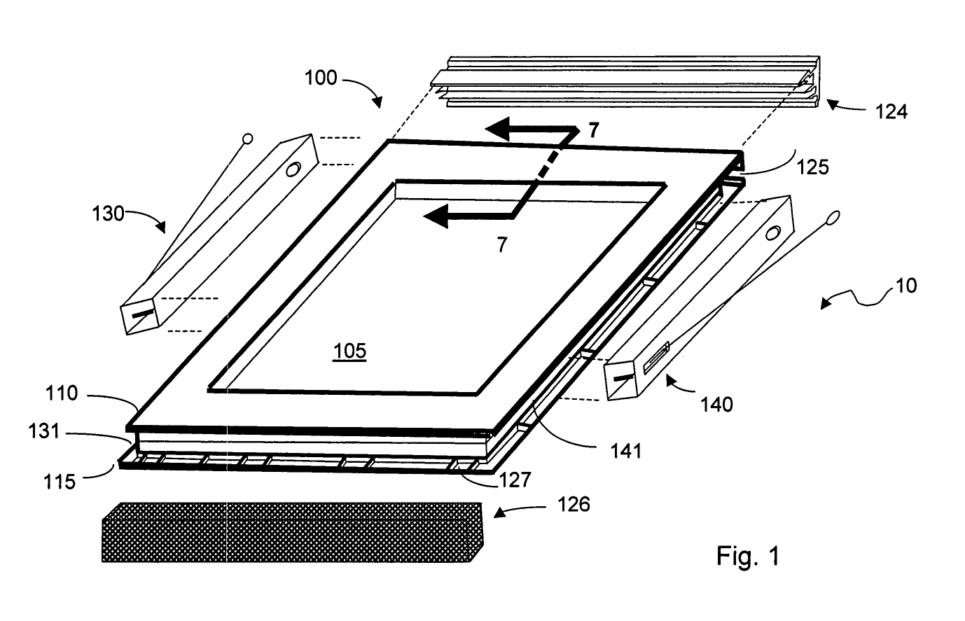

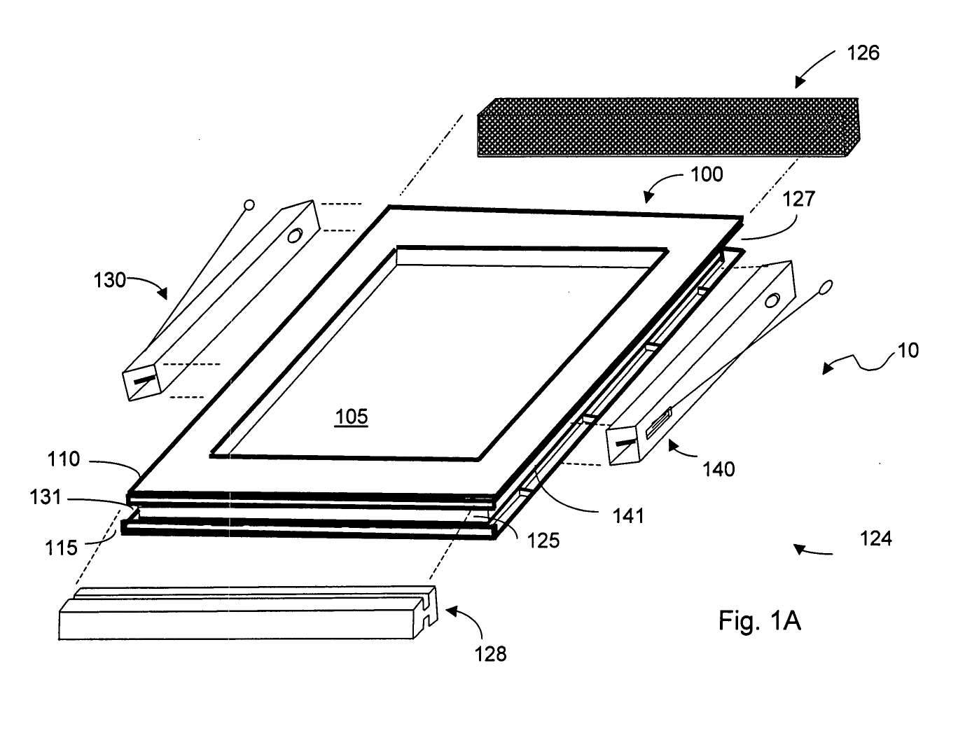

Referring to FIGS. 1 & 2, a window assembly 10 comprises window sash 100 and accessory parts such as balancers 130 and 140, check rail cover 124 to be received, by snap fitting, into channel 125, and bottom rail weather seal 126 to be received into channel 127. In a preferred embodiment, weather seal 126 is a polymeric foam block. The window sash 100 may have additional accessory parts, such as locks, weather stripping, gaskets, and provisions for tilting and removing the sash, as would be apparent to one of ordinary skill in the art.

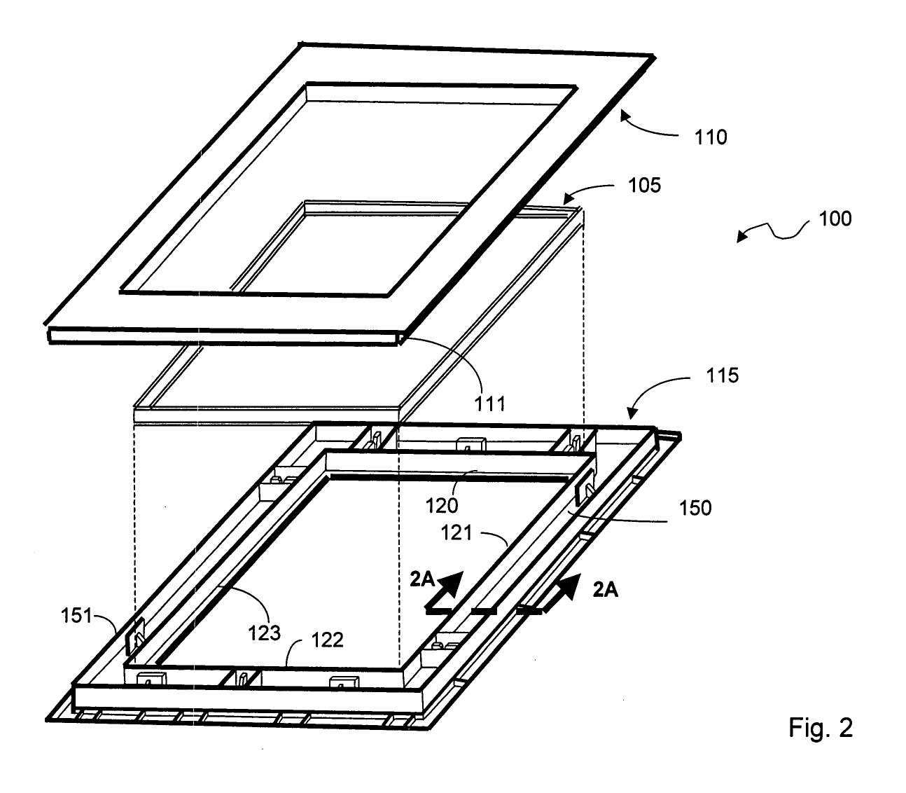

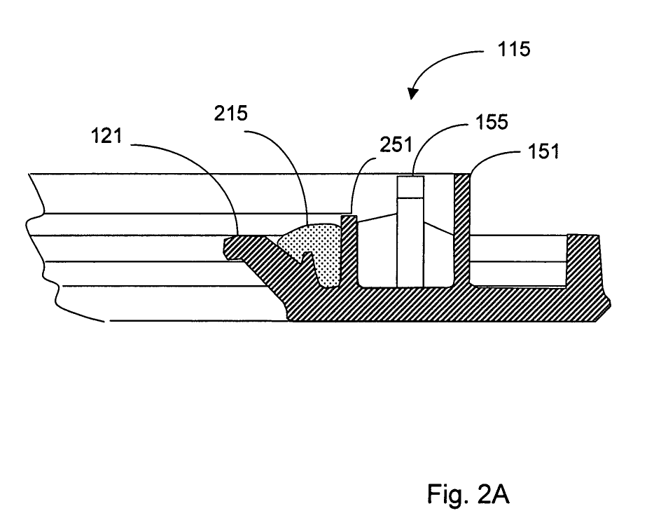

As best shown in FIG. 2, window sash 100 comprises glazing unit 105 and one-piece sash body members 110 and 115. One-piece sash body members 110 and 115 are preferably made by injection molding a polymeric material, thereby resulting in each of the sash body members 110, 115 comprising one continuous piece of polymeric material. Furthermore, each of the sash body members 110, 115 has substantially the same mechanical configuration.

As used herein, components having the same mechanical configuration are components that can be injection molded from the same mold, so that the same mold can be used to produce both of sash body members 110 and 115, thereby reducing tooling costs. It will be appreciated, however, that parts having substantially the same mechanical configuration can be produced in different colors by changing the color of the polymeric material used. It will also be understood that molded parts having molded-in inserts, as might be used for receiving threaded fasteners, or for structural reinforcement, can also be used, without departing from the one-piece definition.

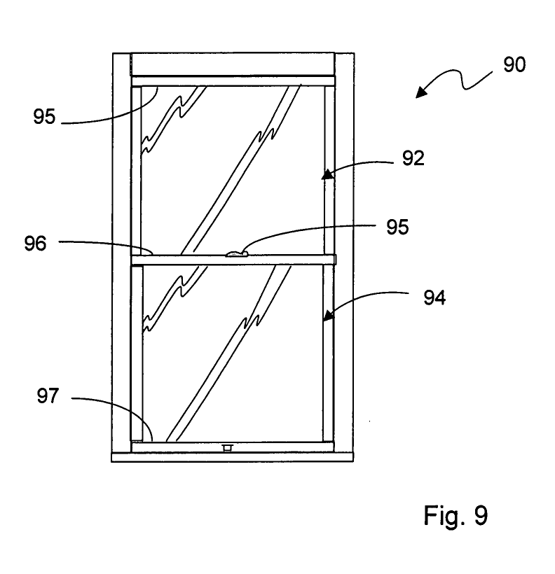

Referring to FIG. 9, window sash 100 can be adapted to produce an upper sash 92 or a lower sash 94 by selection of particular accessory devices, using the same sash body members 110 and 115. FIG. 1 portrays an exploded view of a sash body adapted for use as a lower sash. As best seen in FIG. 1, the balancers 130, 140 fit into corresponding longitudinal recesses 131, 141, respectively, formed along the edges of the window sash 100, between opposing sash body members 110, 115. Balancers 130 and 140 can be of the type shown, for window sashes which allow only sliding in the vertical plane, or can be of the tilting type disclosed, for example, in co-assigned published U.S. Patent Application 2003/0226317 A1, incorporated herein by reference.

Alternatively, the balancers may be attached to the jambs of the window, rather than to the window sash. When balancers are incorporated into the jambs, suitable members can be installed into longitudinal recesses 131 and 141 to enable the sash to slidably engage the jamb and to enable attachment of suitable couplings, such as a cord, cable, or other like member for operably coupling the balancers to the sash.

Channel 125 is adapted to receive check rail cover 124. Cover 124 can include a locking device 95, shown in FIG. 9, for coupling lower sash 94 to upper sash 92, so as to lock the window against intrusion. Check rail cover 124 can also incorporate latching devices to allow a lower sash to be tilted out for ease of washing. Useful latching devices include individually operated sliding or tilting latches which engage the jambs, as well as latching devices coupled to a central actuator, as disclosed in co-assigned published patent application U.S. 2003/0205903 A1, whose contents are incorporated by reference. The various latching devices can be incorporated into check rail cover 124 without modifying sash body member 110 or 115. Bottom rail weather seal 126 can include a gasket or other sealing device, and may also include a groove for engaging a vertical rib, or dam, in the sill of a window frame, for blocking windborne rain. In a preferred embodiment, weather seal 126 comprises a foam block that is conformable to vertical water dams or other features incorporated into the sill.

When sash 100 is adapted for use as an upper sash of a double hung window, such as sash 92, shown in FIG. 9, it can be inverted, to place channel 125 on the bottom of the sash. Referring to FIG. 1A, check rail cover 124 can be replaced by component 128, which engages check rail cover 124 of the bottom sash, for locking and sealing the window unit. In a preferred embodiment, weather seal 126 can be eliminated, and a weather seal can be installed in head jamb 93 of window 90, to provide weather sealing of the top of upper sash 92. Balancers 130 and 140 can be mounted in longitudinal recesses 131 and 141, but inverted relative to sash 100, to account for the inversion of sash 100, while still providing an upward lift to the sash.

The foregoing sash arrangements are merely illustrative of the range of sash models that can be produced from the single sash body configuration of the present invention. Features of sash body 100, particularly channels 125 and 127, as well as longitudinal recesses 131 and 141 of sash body 100, allow for a great variety of accessory devices to be combined in various ways, using the same sash body members 110 and 115, to produce a range of window sash products greater than would be expected from a single one piece sash member configuration.

Window sash 100 can be assembled by fitting glazing unit 105 onto sash body member 115, with a suitable sealing material 215, deposited as shown in FIG. 2A. A suitable sealing material is silicone RTV (room temperature vulcanizing), of the type commonly used in sealing of windows and other structural components. In a preferred embodiment, interior edges 120, 121, 122, and 123 are adapted to provide a bedding surface for glazing unit 105, while walls such as 251 provide positioning surfaces for glazing unit 105, so as to hold glazing unit 105 in a nested position during and after assembly. If the two sash body members are to be welded together, the surfaces to be welded are heated, and then sash body member 110 can be fitted over sash body member 115 and pressed into place. In the event that the interface between sash body members 110 and 115 forms a continuous seal that results in one or more sealed cavities within the sash, suitably located venting may be provided to avoid pressure buildup that may lead to damage.

During assembly, in one embodiment, sash body member 110 can be accurately located relative to sash body member 115 by suitable locators incorporated into the facing sides 150 of the sash body members. Wall 151 can provide a welding surface for attaching sash body members 110 and 115, as well as to provide a barrier to moisture and other environmental contaminants. In another embodiment, in an alternative to locators incorporated into the facing surfaces 150, externally provided fixtures may be used. If such externally applied fixtures are used, reference surfaces marked with arrows or other indicia, and/or other complementary formations, can be provided on the non-facing surfaces of sash body members 110 and 115 to facilitate use of the fixtures. It will be appreciated that while built-in locators are useful, other locating means, such as externally applied fixturing, can also be used.

The type of locators used for locating sash body member 110 relative to sash body member 115 is not particularly limited, provided that the two sash body members are of the same mechanical configuration, so that they can be made from the same mold.

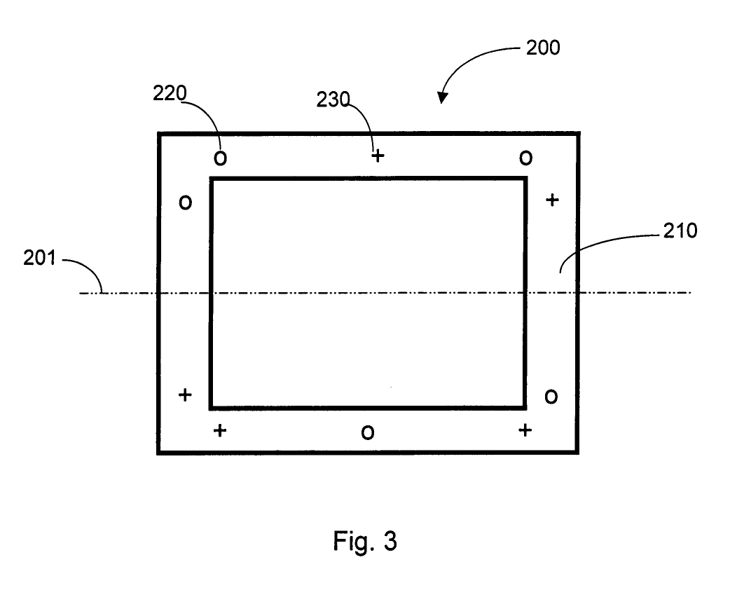

A system of complementary locators can be directly molded into the sash body members, while still allowing both sash body members to be of the same mechanical configuration. Referring to FIG. 3, the inner, facing surface 210 of sash body member 200 is provided with two types of locators. A first type of locator shown as 220, is represented by circles (o), and a second type of locator, shown as 230, is represented by crosses (+). Preferably, the two types of locators are not only different from one another, but also are complementary to each other in the sense that they mate with one another. The first and second types of locators are arranged anti-symmetrically about an axis of anti-symmetry 201, so that rotating a first sash body member about the axis of anti-symmetry 201 places the first and second locators in mating positions.

In FIG. 3, the locators represented by circles are configured to mate with those represented by the crosses. It is understood that while locators that are physically shaped as circles and crosses could be used, this convention can also serve as a symbolic representation of a general class of locators that could be used. For example, the crosses could represent blades, and the circles could represent slots, pockets, or combinations thereof, for receiving the blades.

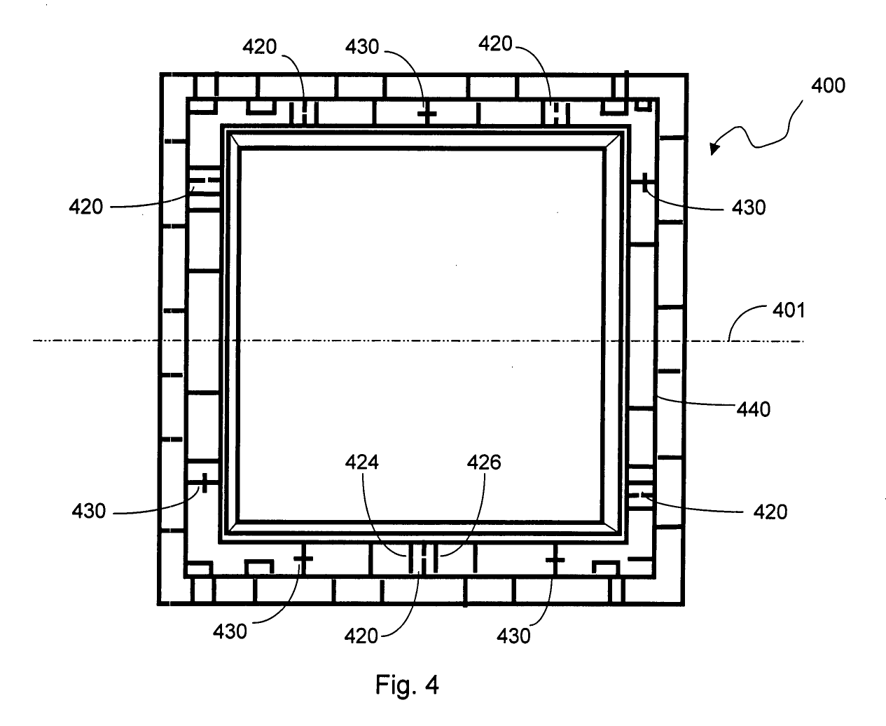

FIG. 4 shows a sash body member 400 having an axis of anti-symmetry 401 about which slot-type locators 420 and blade-type locators 430 are provided on the inner, facing surface. The slot-type locators 420 and the blade-type locators 430 are complementary to one another, and are provided in equal numbers about an inner perimeter of the sash body member 400. As seen in FIGS. 3 and 4, locators of both types are formed on all four sides of a rectangular sash body member.

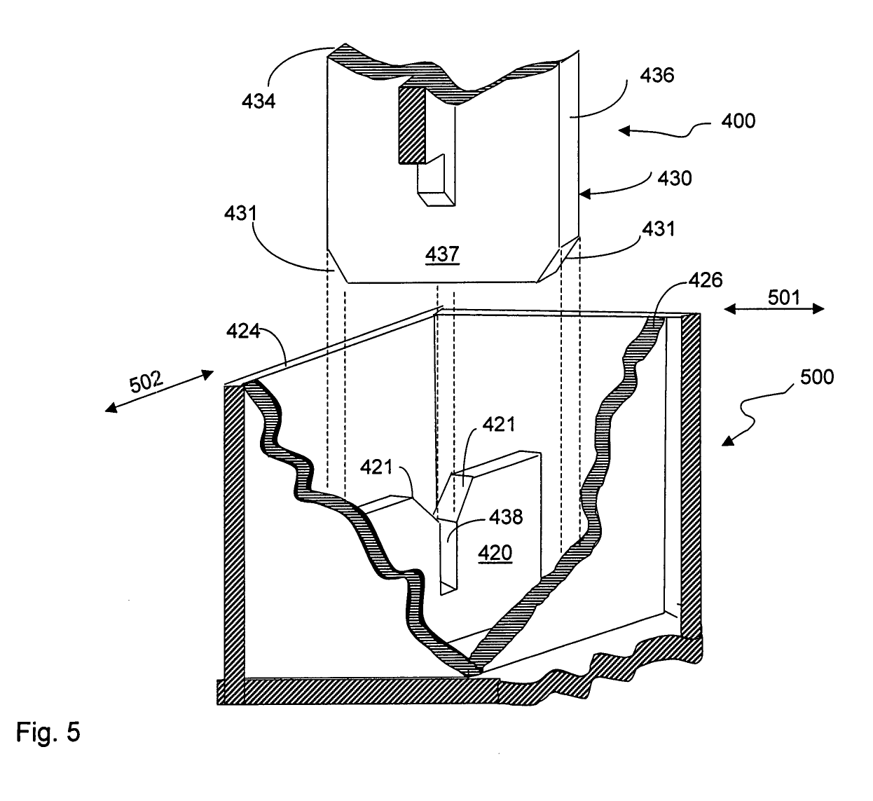

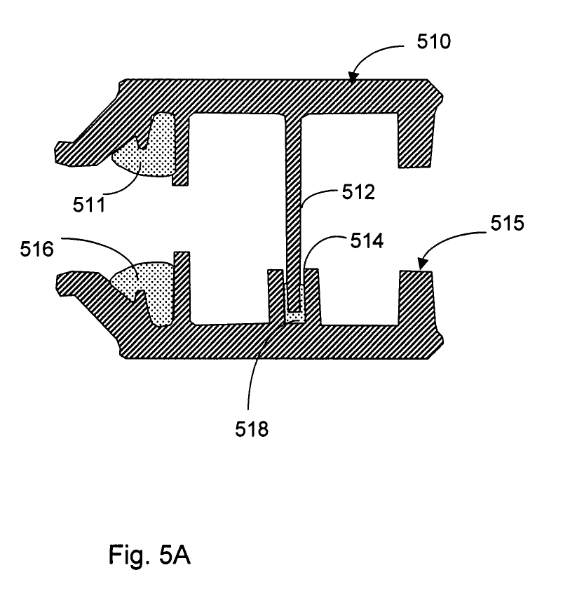

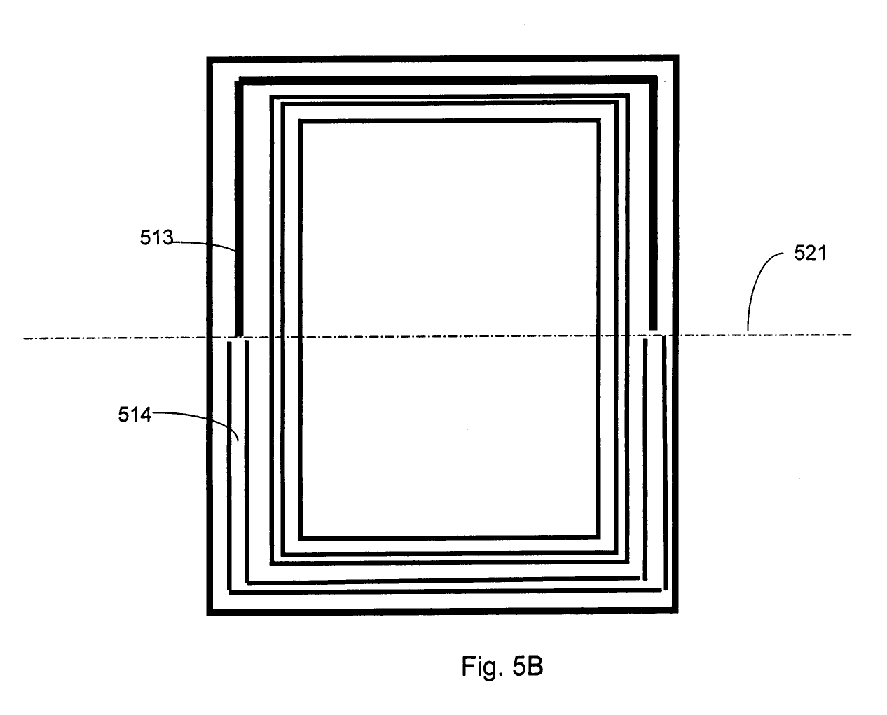

As best seen in FIG. 5, the slot-type locator 420, which is formed on sash body member 500, is a thin-walled member that is parallel to, and between, locator guide walls 424, 426. The slot-type locator 420 comprises a slot 438 whose entry is provided with a pair of sloped receiving walls 421 that face one another. The blade-type locator 430, which is formed on sash member 400, comprises a blade 437 provided with a pair of sloped lateral surfaces 431 connecting to perpendicular end walls 434 and 436.

During assembly, the blade-type locator 430 fits between walls 424 and 426, to locate the first sash body member 400 relative to the second sash body member 500 along direction 501. Meanwhile, the blade 437 fits into slot 438, to locate the first sash body member 400 relative to the second sash body member 500 along direction 502, which is substantially perpendicular to direction 501. Sloped receiving surfaces 421 formed on the slot-type locator 402, and the sloped lateral surfaces 431 formed on the blade-type locator 430 guide the two sash body members into position during assembly.

It is understood that locators of the slot-type and blade-type are not limited to the embodiment described hereinabove. For example, a slot-type locator may comprise a plurality of slots, while a blade-type locator may comprise a corresponding plurality of blades. In addition, in other embodiments, locator guide walls may not be provided.

The slot-and-blade configuration described immediately above has the advantage that the various parts have a relatively thin wall thickness. This is an advantage in injection molding, since sink marks and other irregularities on visible surfaces are often caused by large variations in wall thickness, as might be produced by shrinkage of thick ribs or other internal features of injection molded parts during cooling.

It is also useful to mold in structures internal to the window sash for receiving screws and other fastening devices. In one embodiment, these structures are made relatively thin, so as to avoid surface deformities such as sink marks, while still maintaining significant thickness for receiving at least some threaded fasteners. This increased thread receiving thickness is achieved by providing structures in the form of overlapping tabs, with one tab being provided by each sash body member, so that threaded fasteners pass through both tabs, thereby doubling the thickness of material holding the fastener, while allowing the tab in each sash body member to be relatively thin. Alternatively, structures can be molded into the sash body members for holding metal or other threaded devices which can be installed prior to assembly of the sash body. One useful thread receiving fastener is the Tinnerman™ brand clip for receiving a threaded fastener.

In embodiments wherein sash body members are fastened together by welding, it is useful to provide weldable mating surfaces on each sash body member. Referring again to FIG. 4, a weldable mating surface, preferably in the form of weld wall 440 is provided for this purpose. Weld wall 440 preferably is set back from the outer edges of the sash body member 400. In one embodiment, weld wall 440 is a substantially continuous rib, so that the welded seam also acts as a seal to keep moisture out of any cavities formed by the sash body members after assembly. While it is often useful for various parts of the sash to provide moisture barriers, it will be appreciated that suitably located venting may also be useful in some instances, so as to prevent unwanted or harmful pressure buildup, or to provide drainage. Venting can be achieved by providing notches or other discontinuities in weld wall 440, by drilling holes in appropriate locations, or by other venting means, as would be apparent to one skilled in the art.

Welding of sash body members 400 can be performed by heating the edge of each weld wall 440 to an effective welding temperature, and then pressing the two mating weld walls together. Heating of the weld walls can be performed by, for example, hot plate welding. As is known to those skilled in the art, hot plate welding is typically performed by separating the two surfaces to be welded by a short distance, placing a heated plate, or platen, in contact with the two surfaces for a time sufficient to raise the temperature of the weld surfaces to the welding temperature, removing the platen, pressing the heated surfaces together, and allowing them to cool. The heated platen can be made sufficiently large to accommodate a variety of sizes of parts to be welded. It is also useful to provide a non-adhesive coating, such as Teflon™ on heated surfaces that contact the parts to be welded. It has been recognized, however, that conventional hot plate welding may not always be able to accommodate the variety of sizes and shapes of parts that may need to be welded.

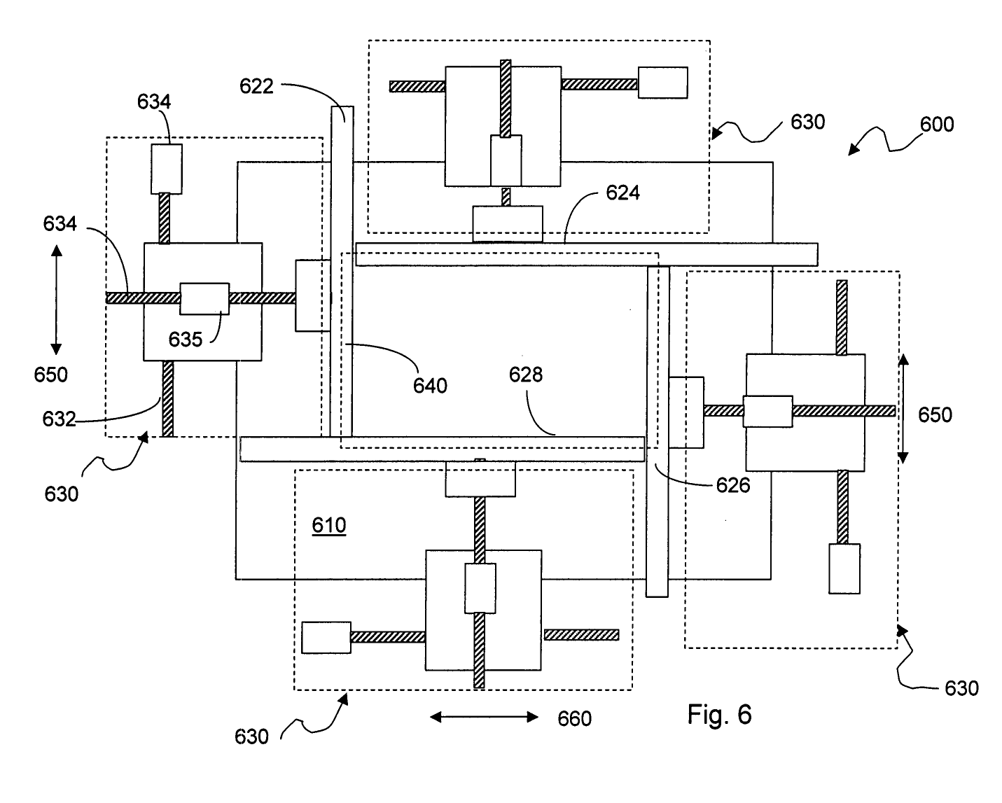

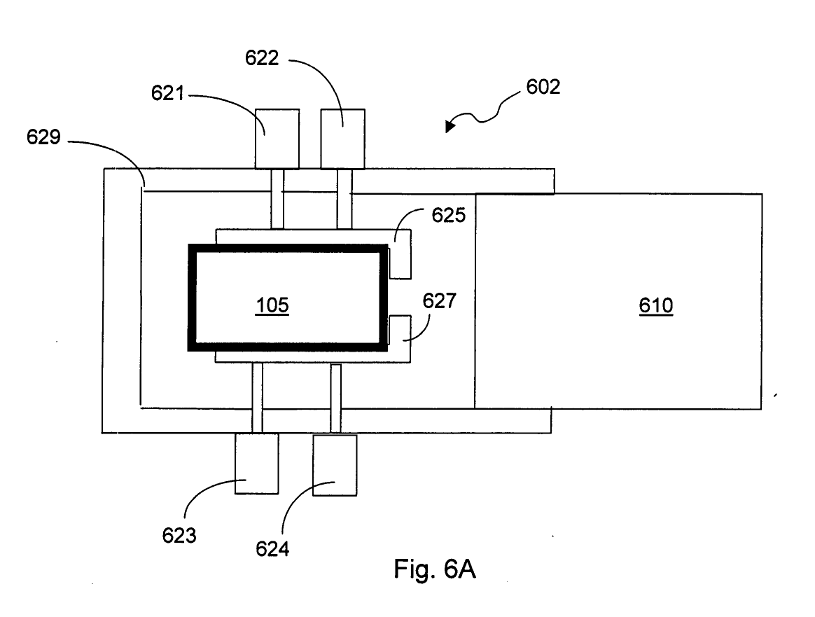

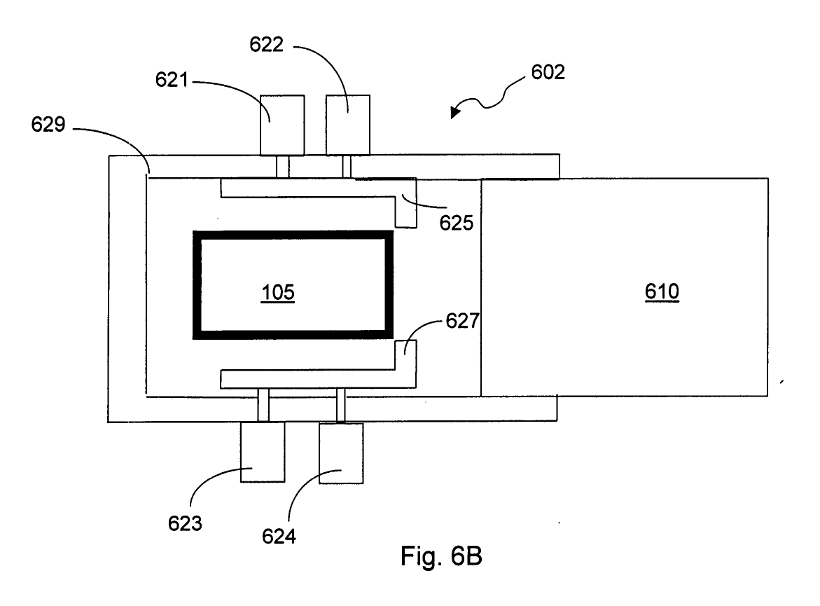

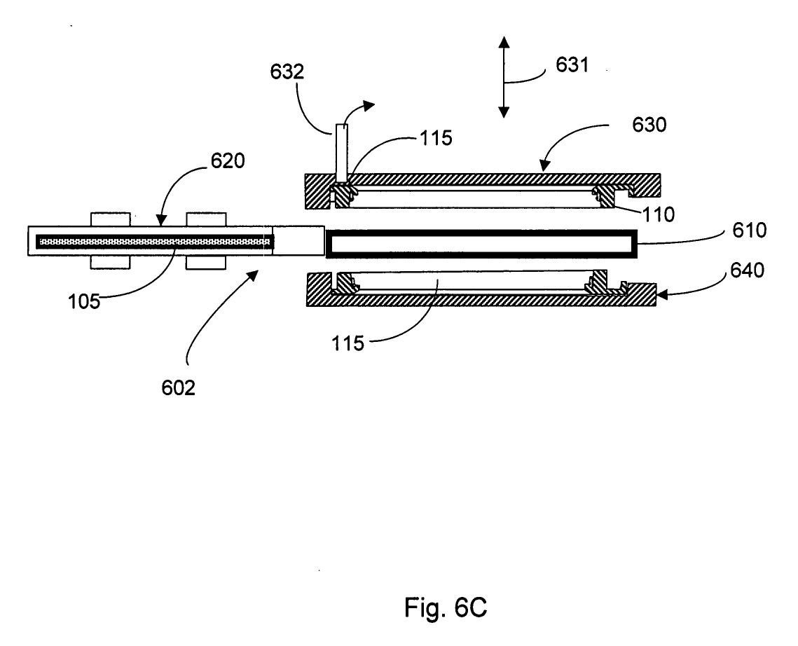

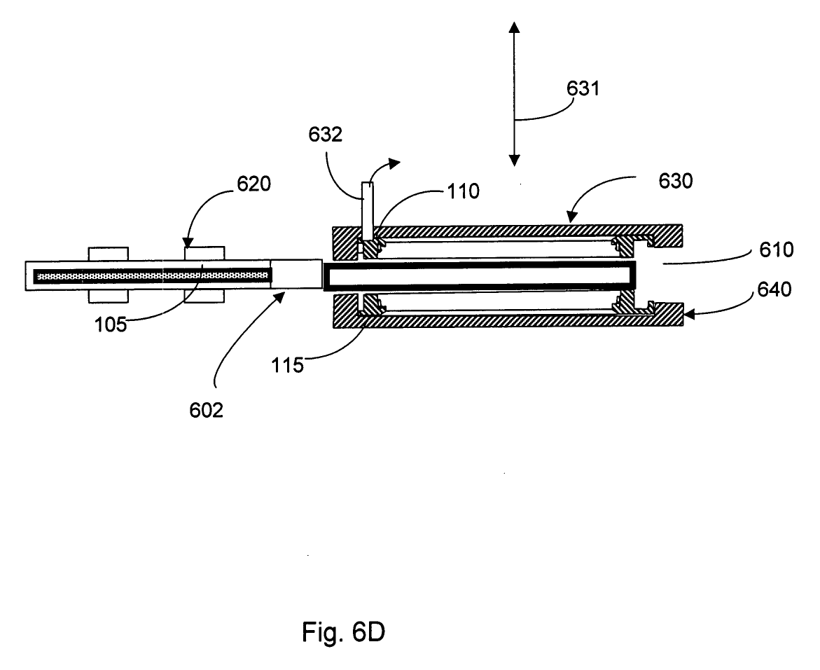

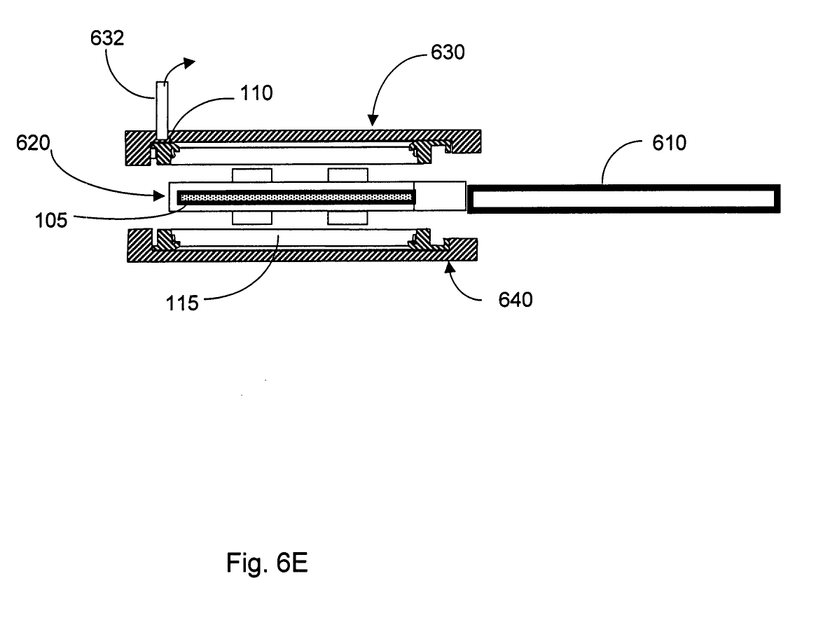

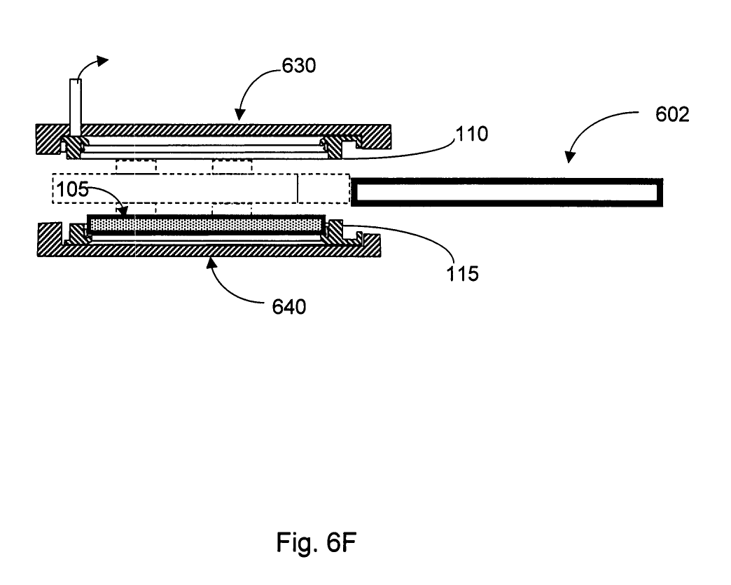

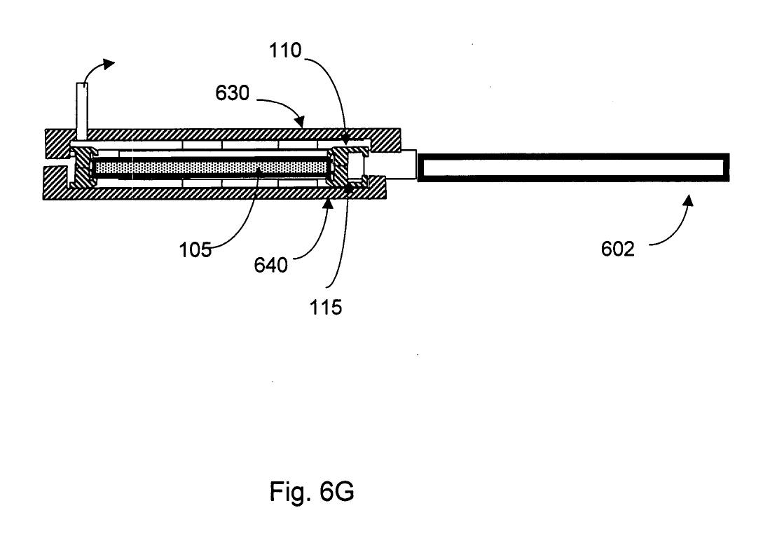

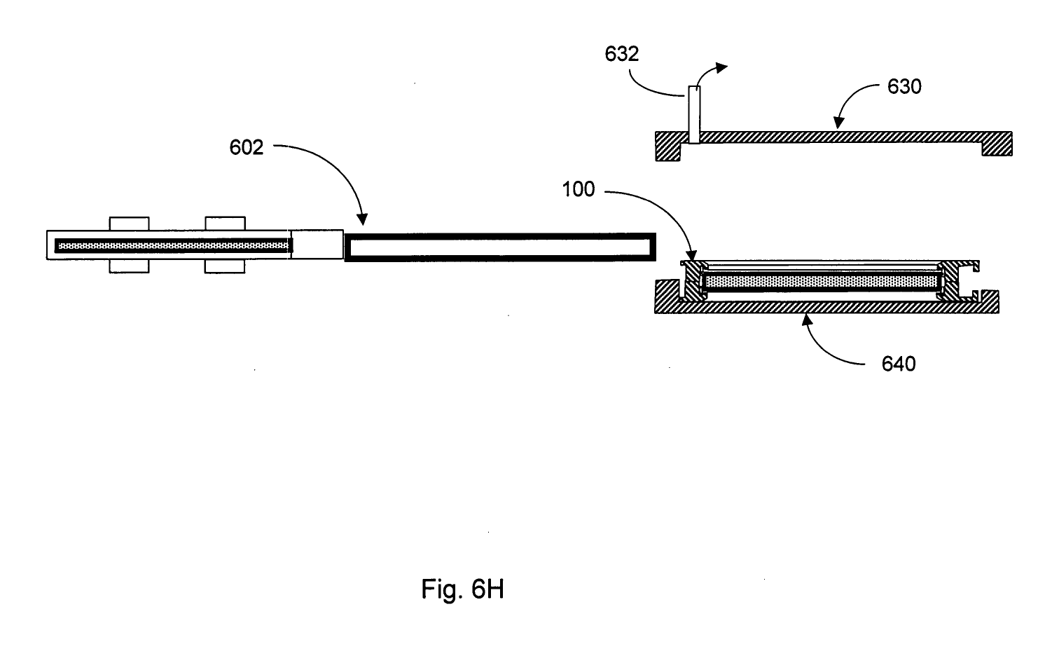

FIG. 6 shows a top view of an alternate welding apparatus 600 for heating limited areas near weld walls, during assembly of a sash window formed of two injection-molded sash body members. Welding apparatus 600 is adapted to weld rectangular sash body members. In one embodiment, heating of the surfaces to be welded is performed by heated bars 622, 624, 626, and 628. Heating of these bars can be accomplished by any suitable means, with electrical heating from embedded resistive elements being particularly useful. With the heated bars in retracted positions, near the edges of table 610, a first of the two sash body members, with glazing unit in place, is placed on table 610, with the side to be welded facing upward, toward the heated bars, in a nesting fixture for precise positioning, with the weld wall positioned as shown by dashed line 640.

The heated bars are then positioned over weld wall 640 by means of positioners 630. Positioners 630 allow movement in two perpendicular directions, using, for example threaded shafts 632 and 634, and drives 635, for moving the bars in directions 650 and 660. Thus, welding apparatus 600 may be able to accommodate a range of sizes of sash bodies to be welded.

Alternative embodiments for positioning the heated bars are also contemplated. In particular, two of the adjacent bars can be fixed, and the sash body members can be positioned relative to these bars, after which the other two heated bars are positioned relative to the sash body members. In other embodiments, the sash body member locating features of the welding apparatus are coupled to the heated bars, so as to determine the location of the heated portions of the sash body members relative to the heated bars. Additionally, apparatus for coupling one heated bar or locating component relative to another, by, for example, rack and pinion linkages for centering a sash body member relative to the welding apparatus, are also contemplated. In addition, while the welding apparatus portrayed hereinabove holds the sash body members in a horizontal orientation during processing, adaptations of the apparatus to allow processing in a vertical orientation, or in an orientation intermediate between vertical and horizontal, are also contemplated.

After positioning the bars, the second of the two sash body members is placed above the bars, and, the upper sash body is then lowered onto the welding bars, which are also lowered onto the lower sash body, so that the welding bars simultaneously contact both surfaces to be welded. This vertical movement can be provided by any suitable lifting apparatus, as would be apparent to one skilled in the art. The sash body members and bars are then held in position for a sufficient time to allow heating of the weld surfaces to the weld temperature, whereupon the upper sash body is lifted a short distance, the bars are lifted and pulled away from the sash body members, using, for example, suitable lifting devises, not shown, and positioners 630. The second sash body member is lowered so that the two sash body members are brought together, and pressed, to form the weld, and thereby create a sash window.

In an alternative embodiment of a welding apparatus 600, the heated bars may be replaced by hollow conduits having a series of holes. The hollow conduits are connected to a hot air source, so that heating of the weld surfaces is achieved by forced air convection.

In an alternative embodiment, a hot plate welding apparatus can be adapted for welding a variety of sizes of sash bodies. Referring to FIGS. 6A and 6B, carriage 602, shown in plan view, comprises hot plate 610 and carrier frame 629. Hot plate 610 can be heated by any suitable means, such as embedded electrical resistance heating elements. Carrier frame 629 serves to hold and position glazing unit 105 using grippers 625 and 627, which are operated by actuators 621, 622, 623, and 624. The actuators may be operated by air pressure, hydraulic pressure, electricity, or other suitable mode of operation, to hold and release glazing unit 105, as shown in FIG. 6B. Carriage 602 is mounted on a suitable traversing and positioning apparatus, not shown, to allow it to move to various positions along a horizontal direction of travel as well as in a vertical direction.

Referring to FIG. 6C, the assembly operation is performed by first depositing sealant on the surfaces of sash body members 110 and 115 that are to receive the glazing unit. Sash body member. 115 is then positioned in lower fixture 640 and member 110 is positioned in upper fixture 630. Fixtures 630 and 640 are adapted for particular sizes of sash bodies, but may be made adjustable to accommodate different sizes. In this embodiment, sash body 110 is held in position in upper fixture 630 by vacuum suction device 632, connected to a vacuum source, not shown. It will be appreciated that other holding devices may also be employed. After positioning sash body members 110 and 115 in their respective fixtures, hot plate 610 is moved into place between the two sash body members

Referring to FIG. 6D, upper fixture 630 is moved downward along direction 631, along with hot plate 610, to bring both sash body members into contact with the hot plate. This position is held until the weld surfaces of sash body members 110 and 115 are sufficiently heated for welding. Fixture 630 is then lifted, along with carriage 602, to allow carriage 602 to move to the glazing installation position, shown in FIG. 6E. Once in position, glazing unit 105 is dropped into sash body member 110 by retracting grippers 625 and 627, as shown in FIG. 6B, to produce the result shown in FIG. 6F. Then, as seen in FIG. 6G, upper fixture 630 is then lowered so as to press upper sash member 110 against lower sash member 115, thereby welding the two sash members together and sandwiching glazing unit 105 therebetween.

Referring to FIG. 6H, vacuum 632 is released, and fixture 630 is raised, and carriage 602 is moved to its home position for loading the next sheet of glass. Completed sash 100 is then lifted from lower fixture 640 and then sent to the next manufacturing step.

Alternative embodiments for hot plate welding apparatus are also contemplated. In particular, hot plate 610 can be a separate part from the glazing unit carrier frame 629, so that hot plate 610 can move independently, possibly in a different direction, from the carrier frame 629. In still other embodiments, the hot plate, sash body member placement, and glazing unit placement apparatus are located at fixed work stations, and the components to be assembled and welded are moved from station to station as work progresses. Alternative embodiments also include holding the components to be assembled, as well as the welded sash, in orientations other than horizontal during and after processing.

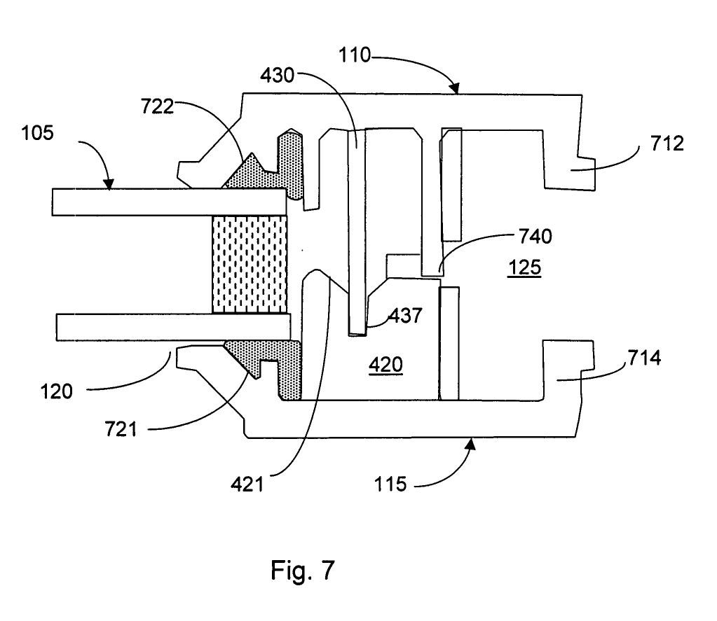

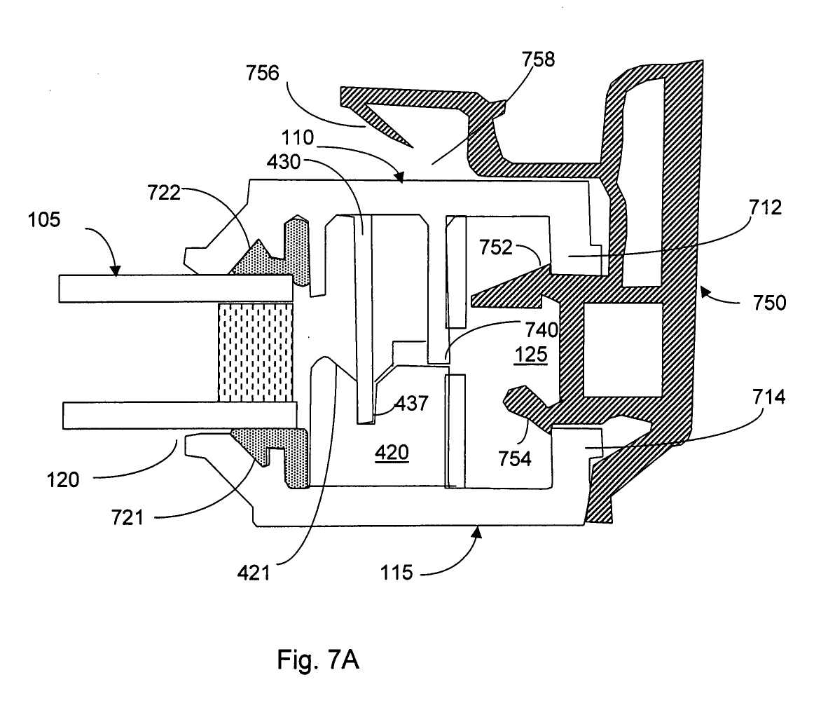

FIG. 7 shows a cross section of an assembled window sash 100 comprising first sash body member 110, second sash body member 115 and glazing 105 sealed in part with silicone beads 721 and 722. Locators 420 and 430 are shown engaged with weld wall welded at weld seam 740. In this embodiment, channel 125 is formed for receiving an accessory part such as check rail cover 750, shown in FIG. 7A. Ribs 712 and 714 serve to hold the check rail in place. A variety of check rail covers can be used with the same sash body, incorporating, for example, different tilt latch mechanisms and window locks. Sash rail cover 750 can be made by extrusion, and a variety of variations on the sash rail can be produced from the same extrusion by cutting notches and other apertures in the extruded member for receiving additional components. This enables several models of windows to be produced using the same sash body members, thereby reducing the cost of the relatively expensive injection mold tooling, while maintaining a viable product line. It is also possible to coextrude different materials to produce a sash rail cover extrusion having different properties at different locations. For example, weather seal interlock portion 756 of sash rail cover can be made of a more flexible material to engage a mating part from an upper sash to form an interlocking weather seal.

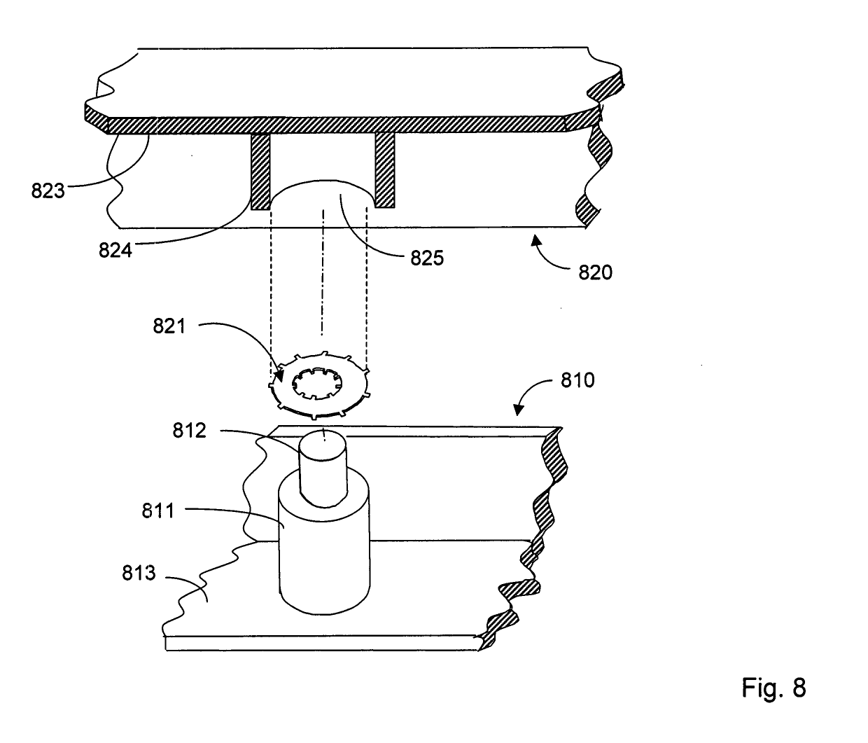

FIG. 8 shows an alternate embodiment for the locators, in which the locators also serve as fastening devices for holding the two sash body members together. In this embodiment, locator 811, on sash body member 810, supports boss 812, which receives locking ring 821. In this embodiment, ring 821 is provided with teeth on its inner diameter to grip boss 812. Tubular locator 824 is provided in sash body member 820 to fit over the outer diameter of ring 821, wherein the outer teeth of ring 821 grip surface 825 of locator to fasten sash member 810 to sash member 820. An alternative embodiment to ring 821 is a thin washer, having a dished, or cone, shape, without teeth, that forms an interference fit between boss 812 and surface 825. Other self locking interference type fasteners may also be used, as would be apparent to one skilled in the art.

Referring to FIG. 5A, locators and fastening devices for the two sash bodies can be combined, FIG. 5A shows a cross section of an assembled sash, wherein channel 514 in sash body member 515 receives wall 512 of sash body member 510, with adhesive 518 holding the two sash body members together. Hot melt polyurethane adhesive has been found useful for this purpose, though other adhesives could also be used. Referring to FIG. 5B, wall 512 and channel 514 can be arranged asymmetrically about axis of asymmetry 521, so that both sash members can be made from the same mold.

FIG. 9 shows a window 90 having a window frame associated with first and second window sashes 92, 94 and locking hardware 95. Such a window may thus comprise four sash body members in accordance with the present invention. Window 90 preferably is a double hung window in which the lower window sash 94 has bottom rail cover 97 and a check rail 96, while the upper window sash 92 has a top member 95. It is understood, however, that the window 90 may instead be single-hung window, in which case only lower window sash 94 is movable. Whether it is single-hung or double-hung, the window sashes 92, 94 in window 90 preferably each comprise first and second one-piece injection molded sash body members and a glazing unit, as described above.

The present invention has been described with respect to specific embodiments. However, it will be appreciated that modifications and variations of the present invention are covered by the above teachings and within the purview of the appended claims without departing from the spirit and intended scope of the invention.

What is claimed is:

1. A window sash comprising:
first and second sash body members having substantially the same mechanical configuration and engaged to another; and
a glazing unit held between the first and second sash body members;
wherein each of the first and second sash body members is a one-piece, injection molded component.

2. The window sash according to claim 1, wherein:
each of the first and second sash body members has a facing surface provided with a plurality of locators, the locators on the first sash body member are engaged to the locators on the second sash body member.

3. The window sash according to claim 2, wherein:
each of the first and second sash body members is provided with locators of a first type and locators of a second type, the locators of the first and second types being different from one another and complementary to each other.

4. The window sash according to claim 3, wherein:
locators of the first type each comprise a slot and locators of the second type each comprise a blade.

5. The window sash according to claim 3, wherein:
on each sash body member, the locators of the first and second types are arranged anti-symmetrically about an axis.

6. The window sash according to claim 3, wherein:
each sash body member is four-sided; and
locators of both first and second types are provided on each of the four sides.

7. The window sash according to claim 2, wherein the locators are all identical.

8. The window sash according to claim 7, wherein the locators comprise holes formed in the facing surface of each sash body member, a plurality of first holes in the first sash body member opposing second holes formed in the second sash body member.

9. The window sash according to claim 7, further comprising a pin received in each of said opposing first and second holes.

10. The window sash according to claim 1, wherein each of the sash body members further comprises a weldable mating surface.

11. The panel as recited in claim 10 wherein the weldable mating surfaces comprises a substantially continuous rib.

12. The window sash according to claim 1, further comprising a recess configured to receive a balancer.

13. The window sash according to claim 1, further comprising a recess configured to receive a check rail component.

14. The window sash according to claim 1, wherein each sash body member has a different color, such that one side of the window sash has a different color than the other side of the window sash.

15. A window comprising a window frame in combination with at least one window sash, wherein the least one window sash comprises:
first and second sash body members having substantially the same mechanical configuration and joined to another; and
a glazing unit held between the first and second sash body members;
wherein each of the first and second sash body members is a one-piece, injection molded component.

16. The window according to claim 15, wherein the window is provided with two such window sashes, and is a single-hung window.

17. The window according to claim 15, wherein the window is provided with two such window sashes, and is a double-hung window.

18. A one-piece injection molded window sash body member comprising:
a facing surface, and a non-facing surface;
a first plurality of locators of a first type and a second plurality of locators of a second type provided on the facing surface, the locators of the first and second types being different from one another and complementary to each other; wherein:
the locators of the first and second types are arranged anti-symmetrically about an axis of the facing surface; and
the sash body member is four-sided, with and locators of both first and second types provided on each of four sides.

19. The one-piece injection molded window sash body member according to claim 18, wherein:
locators of the first type each comprise a slot and locators of the second type each comprise a blade.

20. A window sash comprising:
first and second sash body members having substantially the same mechanical configuration and engaged to one another; and
a glazing unit held between the first and second injection molded sash body members;
wherein the first and second sash body members are originally formed from identical injection molds and are subsequently joined to one another.

21. A method of manufacturing a plurality of window sashes comprising:
providing at least four one-piece, injection-molded sash body members having substantially the same mechanical configuration, each of the sash body members having a facing surface provided with a plurality of locators for engaging to another of said sash body members;
assembling a first window sash with first and second sash body members;
providing the first window sash with a first functional capability;
forming a second window sash with third and fourth sash body members;
providing the second window sash with a second functional capability;
wherein the first and second functional capabilities are different from one another.

22. The method of manufacturing a plurality of window sashes according to claim 21, wherein the first and second functional capabilities are selected from the group consisting of tilting, locking, sliding and weatherproofing.
